(19) United States
(12) Patent Application Publication
(10) Pub. No.: US 2006/0005667 A1
(43) Pub. Date: Jan. 12, 2006

(54) Vibration-damping hammer

(76) Inventor: Yi-Kung Hung, Changhua Hsien (TW)

Correspondence Address: BINGHAM, MCCUTCHEN LLP, THREE EMBARCADERO CENTER, 18 FLOOR, SAN FRANCISCO, CA, 94111-4067, US

(21) Appl. No.: 10/884,960

(22) Filed: Jul. 7, 2004

(51) Int. Cl. B25D 1/12

(52) U.S. Cl. 81/22

(57) ABSTRACT

A vibration-damping hammer has a head with a neck portion, a handle attached to the neck portion and at least one damping hole defined in the head, particularly in the neck. The at least one damping hole makes the neck sufficiently flexible and mitigates vibration transmission and so eliminates most vibrating energy. Therefore, the hammer has less vibration whereby the comfort enables the user to avoid working injury.

### BACKGROUND OF THE INVENTION

1. Field of the Invention

The present invention relates to a hammer, and more particularly to a hammer that has vibration-damping efficiency.

2. Description of Related Art

Conventional hammers typically include a steel or iron head immovably mounted on a handle that is usually covered with a flexible and anti-slip sleeve to provide a gripping surface. However, because the head is directly connected with the handle without a vibration damping design, when striking the head against an object, such as a nail or chisel, vibrations will be transmitted through the handle to the hand of the user. Over a period of usage, the vibrations can cause discomfort or even injury to a user's wrist.

The present invention has arisen to mitigate or obviate the disadvantages of the conventional hammer.

### SUMMARY OF THE INVENTION

The main objective of the present invention is to provide a vibration-damping hammer that has multiple holes defined near a head to provide a shock minimizing efficiency.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a vibration-damping hammer in accordance with the present invention;

FIG. 2 is a top plane view of the vibration-damping hammer in FIG. 1; and

FIG. 3 is a partially cross-sectional side plane view of the vibration-damping hammer, wherein the hammer is adapted to break a steel rod.

### DETAILED DESCRIPTION OF THE PREFERRED EMBODIMENT

A vibration-damping hammer in accordance with the present invention comprises a head with a neck portion, a handle and at least one damping hole defined in the head, particularly in the neck. The at least one damping hole makes the neck more flexible and mitigates vibration transmission, whereby most vibrating energy is eliminated. Therefore, the hammer has less vibration whereby the comfort enables the user to avoid working injury.

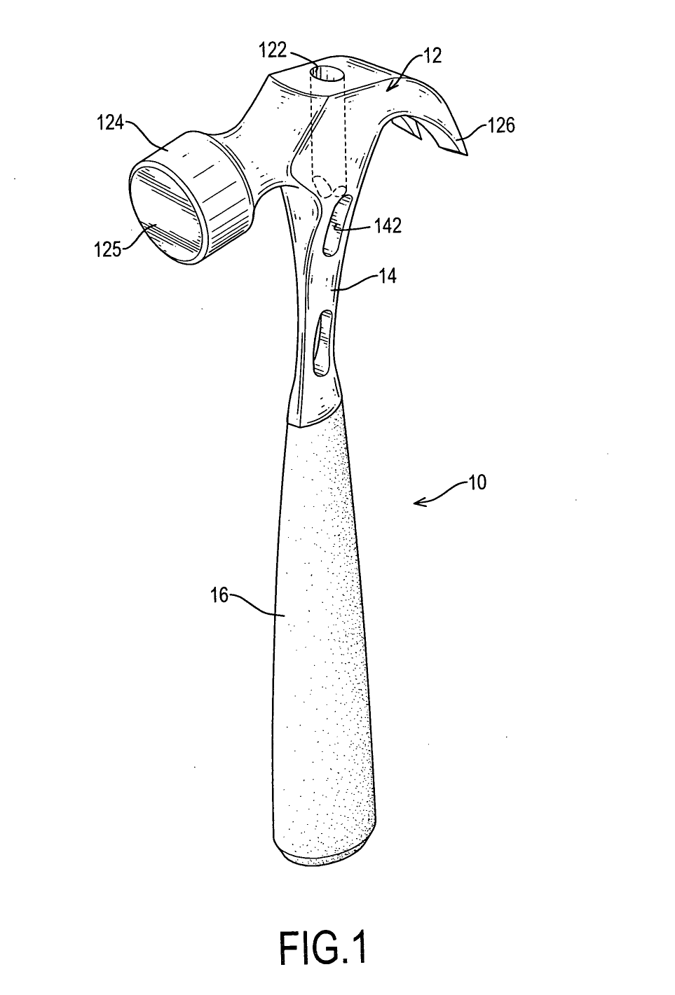

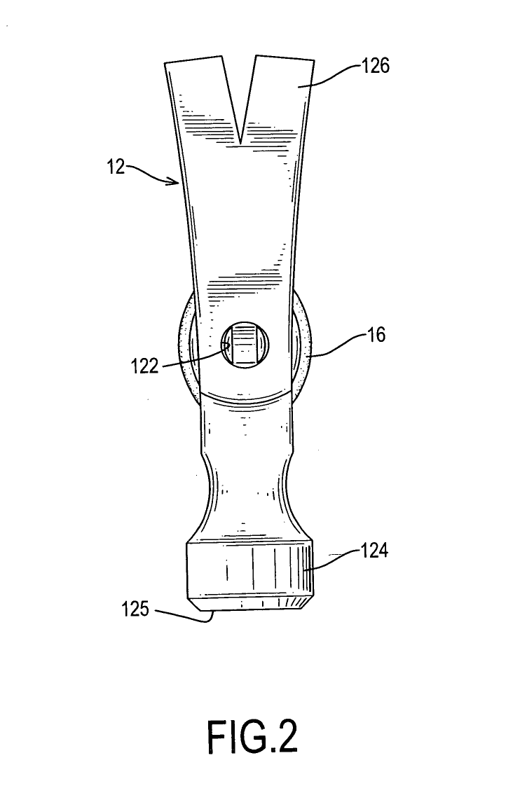

With reference to FIGS. 1 and 2, a preferred embodiment of the vibration-damping hammer (10) comprises a head (12), a neck (14), a handle (16), at least one damping hole (142) and an optional rod hole (122) defined in the head (12).

The head (12) has a top face, a cylindrical front end (124) with a striking surface (125), and a tapered forked end (126) for removing nails (not shown). The striking surface (125) is adapted to strike an object when the hammer is swung. The tapered forked end (126) serves as a claw to grip and pull the nails up by levering the head (12). The neck (14) is integrally formed between the front end (124) and the tapered forked end (126) below the top face. The rod hole (122) is defined in the head (12) from the top face to extend to the neck (14).

The neck (14) has two sides and the at least one damping hole (142) longitudinally defined from one side to the other side of the neck (14), wherein two damping holes (142) are preferred. Particularly, one of damping holes (142) closest to the head (12) is preferably aligned with and communicating with the rod hole (122).

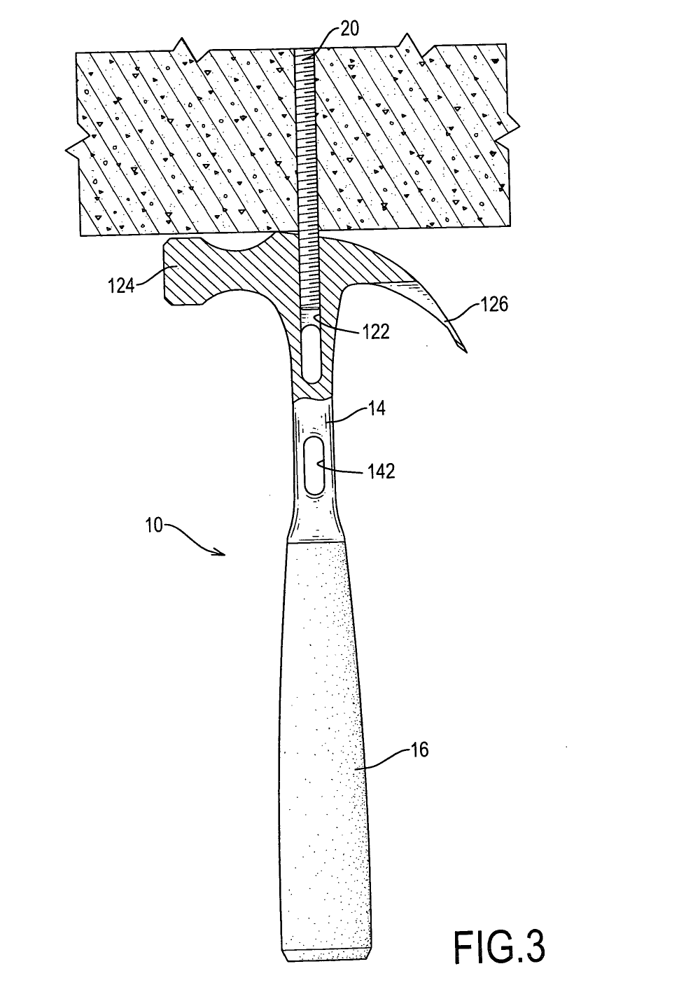

With reference to FIG. 3, when the hammer (10) breaks a steel rod (20) attached on a working surface, the rod hole (122) receives a part of steel rod (20) inside until the top face of the hammer (10) abuts the working surface. Then, the hammer (10) is levered to the tapered forked end (126) to break the steel rod (20). Particularly, when the rod hole (122) communicates with the corresponding damping hole (142), the long steel rod (20) also can be broken by the vibration-damping hammer (10) of the present invention.

The damping holes (20) are longitudinally defined in the neck (14) to eliminate the vibration gradually. When the vibration-damping hammer (10) strikes an object, the at least one damping hole (142) intercepts the vibration and greatly eliminates parts of the vibration to the air since the neck (14) is sufficiently flexible to emit vibrating energy. Therefore, most of the vibration is eliminated at the neck (14) to keep the user safe from working injury.

Although the invention has been explained in relation to its preferred embodiment, it is to be understood that many other possible modifications and variations can be made without departing from the spirit and scope of the invention as hereinafter claimed.

What is claimed is:

1. A vibration-damping hammer comprising:
a head (12) having a top face, a front end (124) with a striking surface (125), and a tapered forked end (126);
a neck (14) integrally connected to the head (12) between the front end (124) and the tapered forked end (126);
a handle (16) combined with the neck (14); and
at least one damping hole (142) defined in the neck (14).

2. The vibration-damping hammer as claimed in claim 1, wherein a rod hole (122) is longitudinally defined in the head (12).

3. The vibration-damping hammer as claimed in claim 1, wherein a rod hole (122) aligns with and communicates with one of the at least one damping hole (142) closest to the rod hole (122).

4. The vibration-damping hammer as claimed in claim 1, wherein the vibration-damping hammer has two damping holes (142) longitudinally defined in the neck (14).

5. The vibration-damping hammer as claimed in claim 2, wherein the vibration-damping hammer has two damping holes (142) longitudinally defined in the neck (14).

6. The vibration-damping hammer as claimed in claim 3, wherein the vibration-damping hammer has two damping holes (142) longitudinally defined in the neck (14).
